(19) United States
(12) Patent Application Publication
(10) Pub. No.: US 2018/0077113 A1
(43) Pub. Date: Mar. 15, 2018

(54) METHOD FOR AUTOMATIC DISTRIBUTION OF IP ADDRESS, SYSTEM AND CLIENT USING THE SAME

(71) Applicants: HONGFUJIN PRECISION ELECTRONICS (TIANJIN) CO.,LTD., Tianjin (CN); HON HAI PRECISION INDUSTRY CO., LTD., New Taipei (TW)

(72) Inventors: MING-GE SHIE, New Taipei (TW); CHIN-LIANG CHEN, New Taipei (TW); ZHANG-GANG WANG, New Taipei (TW); JIA-RU YANG, New Taipei (TW)

(21) Appl. No.: 15/260,334

(22) Filed: Sep. 9, 2016

(51) Int. Cl. H04L 29/12

(52) U.S. Cl. CPC H04L 61/2015; H04L 61/6022; H04L 61/103

(57) ABSTRACT

A method for automatically distributing IP address, which is applied to a switch in communication with all clients having a MAC address and a network segment where all clients are located, comprises automatic issues or assignments of an IP address in response to ARP requests and detecting within a first waiting period which is of random length for each client whether an IP address assigned to a client conflicts with that of other clients. The assigned IP address of the client is unchanged when the IP address of the client does not conflict with other client but, subject to a MAC condition, is released for future non-use after a second random waiting time in case of IP address conflicts between clients. An IP address automatic distribution system and a client are also disclosed.

### FIELD

The subject matter herein generally relates to IP address automatic distribution system.

### BACKGROUND

IP addresses can be automatically distributed to clients based on Dynamic Host Configuration Protocol (DHCP). A DHCP server processes DHCP request from the client and distributes an IP address to the client. Thus, to issue IP addresses based on DHCP, a DHCP server is essential.

### BRIEF DESCRIPTION OF THE DRAWINGS

Implementations of the present technology will now be described, by way of example only, with reference to the attached figures.

FIG. 1 is a schematic view of a system for automatically distributing IP address.

FIG. 2 is a block diagram of the system in FIG. 1.

FIG. 3 is a flowchart of a method of distributing IP address according to an exemplary embodiment.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A definition that applies throughout this disclosure will now be presented.

The term “comprising” means “including, but not necessarily limited to”; it specifically indicates open-ended inclusion or membership in a so-described combination, group, series, and the like.

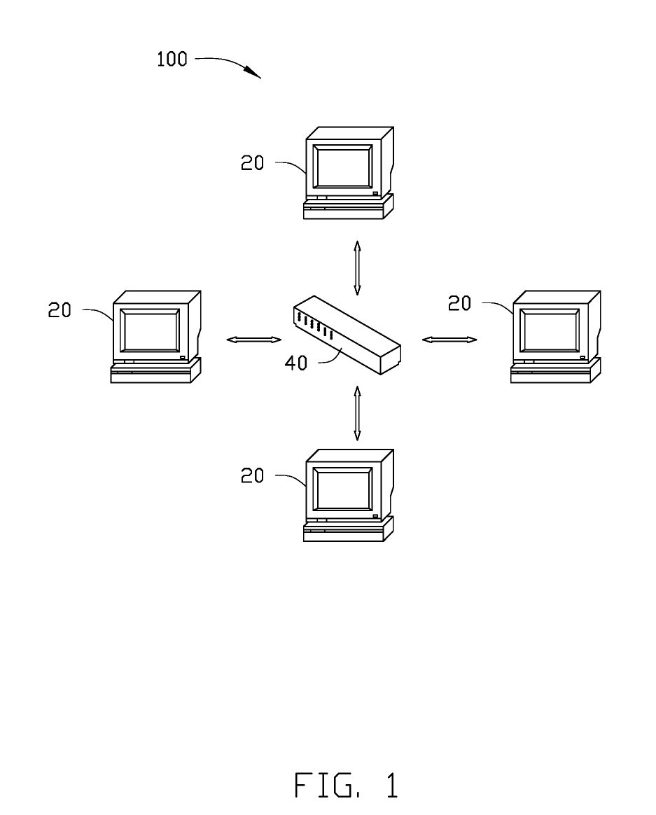

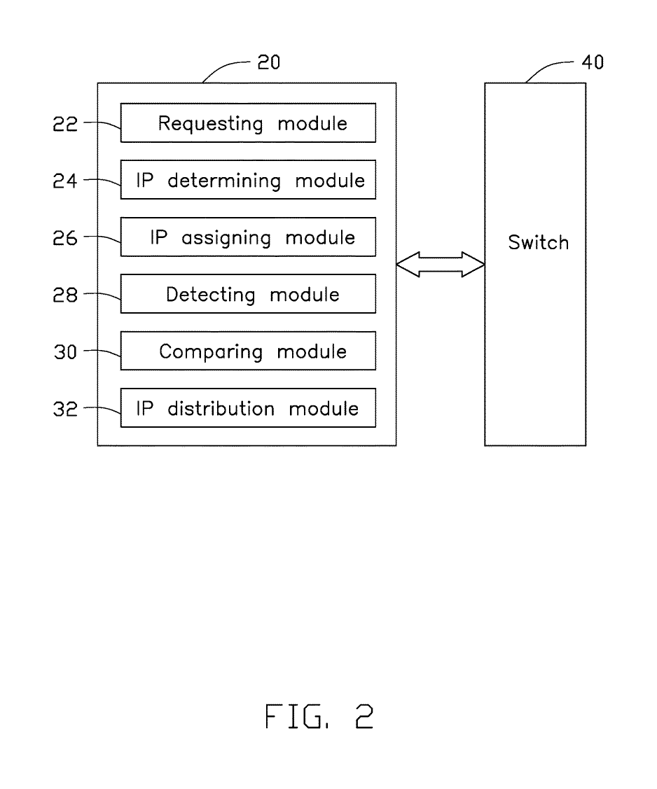

The instant disclosure provides an internet protocol (IP) address automatic distribution system 100. FIG. 1 illustrates the IP address automatic distribution system 100 including a number of clients 20 and a switch 40. The clients 20 communicate with the switch 40. The IP address automatic distribution system 100 is configured to distribute IP addresses to the clients 20. The clients 20 are located in a same network segment. FIG. 2 illustrates that the client 20 includes a requesting module 22, an IP determining module 24, an IP assigning module 26, a detecting module 28, a comparing module 30, and an IP distribution module 32.

The requesting module 22 is configured to send an address resolution protocol (ARP) request to the switch 40 after a first random waiting time. The first random waiting time may be larger than five seconds. In an embodiment, each client 20 may have a different first random waiting time. In another embodiment, at least two clients 20 have a same first random waiting time. The switch 40 transmits individual address information of other clients 20 in response to the ARP request. The address information per client 20 includes IP address and media access control (MAC) address of the client 20. The IP determining module 24 is configured to determine an IP address which has not been used by other client 20 according to the address information and the network segment. The IP assigning module 26 is configured to assign the IP address to the client 20.

The detecting module 28 is configured to detect whether the assigned IP address of the client 20 conflicts with respective IP addresses of other clients 20 after the assignment. In an embodiment, the detecting module 28 can detect whether the IP address of the client 20 conflicts with other client 20 through an ARP command. When IP address of the client 20 is found to be in conflict with one of other clients 20, the comparing module 30 is configured to compare values of MAC addresses of clients 20 which conflict, to determine whether the value of the MAC address of the client 20 meets a preset condition. In an embodiment, the preset condition is the value of the MAC address of the client 20 being the smallest. In another embodiment, the preset condition is the value of the MAC address of the client 20 is the largest. The detecting module 28 is further configured to again detect whether the assigned IP address of the client 20 conflicts with other clients 20 after a second random waiting time when the IP address of the client 20 is not in conflict with other clients 20. In an embodiment, each of the clients 20 may have a waiting time which is randomly different (second random waiting time). In another embodiment, the clients 20 may have a waiting time which is the same length.

The IP distribution module 32 is configured to release the assigned IP address of the client 20 when the MAC address of the client 20 does not meet the preset condition. The IP distribution module 32 is further configured to release the assigned address of the client 20 when the IP address of the client 20 is in conflict with one of other clients 20 at the second random waiting time. The distribution module 32 is further configured to keep the assigned IP address of the client 20 when the IP address of the client 20 does not conflict with other client 20 at the second random waiting time. The switch 40 records the IP address which is assigned and not released and the MAC address of the client 20 when there is no conflict.

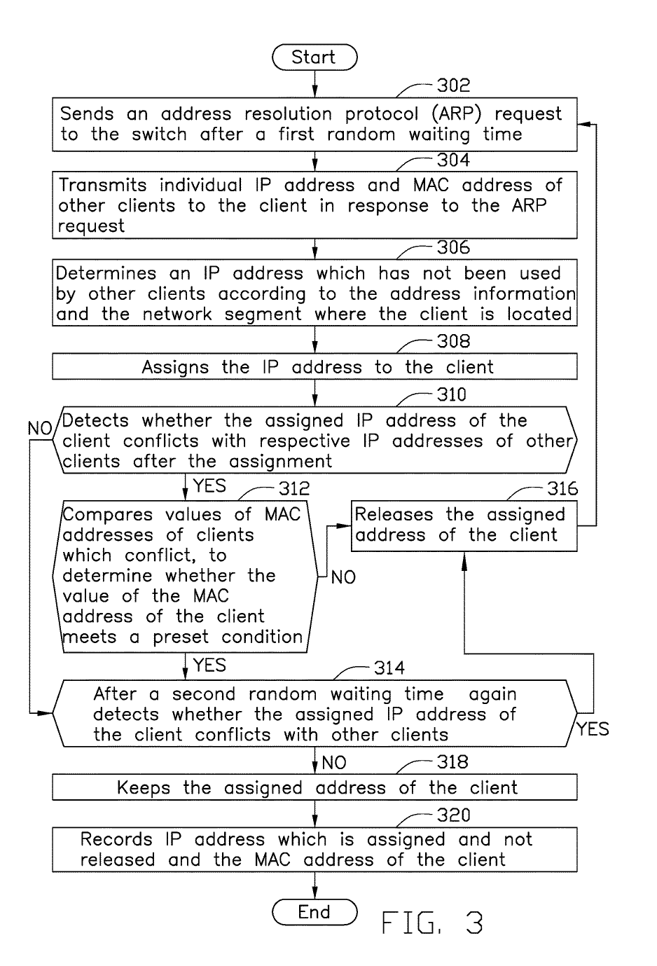

FIG. 3 illustrates a method of distributing IP address according to an embodiment. The order of blocks in FIG. 3 illustrative only and the order of the blocks can change. Additional blocks can be added or fewer blocks may be utilized without departing from this disclosure. The exemplary method begins at block 302.

At block 302, the requesting module 22 sends an address resolution protocol (ARP) request to the switch 40 after a first random waiting time.

At block 304, the switch 40 transmits individual IP address and MAC address of other clients to the client 20 in response to the ARP request.

At block 306, the IP determining module 24 determines an IP address which has not been used according to the address information and the network segment where the client 20 is located.

At block 308, the IP assigning module 26 assigns the IP address to the client 20.

At block 310, the detecting module 28 detects whether the assigned IP address of the client 20 conflicts with respective IP addresses of other clients 20 after the assignment. In an embodiment, the detecting module 28 detects whether the assigned IP address of the client 20 conflicts with other client 20 through sending an ARP command. If the assigned IP address of the client 20 conflicts with one of other clients 20, the procedure goes block 312, otherwise the procedure goes to block 314

At block 312, the comparing module 30 compares values of MAC addresses of clients 20 which conflict, to determine whether the value of the MAC address of the client 20 meets a preset condition. If the MAC address of the client 20 meets the preset condition, the procedure goes block 314, otherwise the procedure goes to block 316.

At block 314, after a second random waiting time, the detecting module 28 again detects whether the assigned IP address of the client 20 conflicts with other clients 20. If the assigned IP address of the client 20 conflicts with one of other clients 20, the procedure goes block 316, otherwise the procedure goes to block 318.

At block 316, the IP distribution module 32 releases the assigned address of the client 20.

At block 318, the IP distribution module 32 keeps the assigned address of the client 20.

At block 320, the switch 40 records IP address which is assigned and not released and the MAC address of the client 20.

The embodiments shown and described above are only examples. Even though numerous characteristics and advantages of the present technology have been set forth in the foregoing description, together with details of the structure and function of the present disclosure, the disclosure is illustrative only, and changes may be made in the detail, comprising in matters of shape, size, and arrangement of the parts within the principles of the present disclosure, up to the full extent established by the broad general meaning of the terms used in the claims.

What is claimed is:

1. An IP address automatic distribution system for distributing internet protocol (IP) addresses to a plurality of clients, the IP address automatic distribution system comprising:
a switch configured to transmits IP addresses and media access control (MAC) addresses of clients; and
the plurality of clients communicating with the switch, the clients located in a same network segment, each client comprising:
an IP determining module configured to determine an IP address which has not been used according to IP addresses and MAC addresses of other clients transmitted from the switch and the network segment;
an IP assigning module configured to assign the IP address to the client;
a detecting module configured to detect whether the assigned IP address of the client conflicts with respective IP addresses of other clients after the assignment and again detect whether the assigned IP address of the client conflicts with other clients after a random waiting time when the IP address of the client is not in conflict with other clients; and
a distribution module configured to keep the assigned IP address of the client when the IP address of the client is not in conflict with other clients at the random waiting time.

2. The IP address automatic distribution system as claimed in claim 1, wherein the client further comprises a requesting module, the requesting module is configured to send an address resolution protocol (ARP) request to the switch after another random waiting time, the switch transmits the IP addresses and the MAC addresses of other clients to the client in response to the (ARP) request.

3. The IP address automatic distribution system as claimed in claim 2, wherein the another random waiting time is larger than five seconds.

4. The IP address automatic distribution system as claimed in claim 1, wherein the detecting module detects whether the assigned IP address of the client conflicts with other client through an ARP command.

5. The IP address automatic distribution system as claimed in claim 1, wherein the switch further records the IP address which is assigned and not released and the MAC address of the client when there is no conflict.

6. The IP address automatic distribution system as claimed in claim 1, wherein the IP distribution module is further configured to release the assigned IP address of the client when the IP address of the client is in conflict with one of other clients at the random waiting time.

7. The IP address automatic distribution system as claimed in claim 1, wherein the client further comprising a comparing module, the comparing module is configured to compare values of MAC addresses of clients which conflict, to determine whether the value of the MAC address of the client meets a preset condition if the assigned IP address of the client is in conflict with one of other clients, the detecting module again detects whether the IP address of the client conflicts with other clients after the random waiting time when the value of the MAC address of the client meets a preset condition.

8. The IP address automatic distribution system as claimed in claim 7, wherein the IP distribution module is further configured to release the assigned address of the client when the MAC address of the client does not meet the preset condition.

9. The IP address automatic distribution system as claimed in claim 7, wherein the preset condition is the value of the MAC address of the client being the smallest.

10. The IP address automatic distribution system as claimed in claim 7, wherein the preset condition is the value of the MAC address of the client being the largest.

11. An internet protocol (IP) address automatic distribution method for distributing IP addresses to a plurality of clients, the IP address automatic distribution method comprising:
determining an IP address which has not been used by other clients according to IP addresses and media access control (MAC) addresses of the other clients transmitted from a switch communicating with all of the clients and a network segment where all of the clients are located;
assigning the IP address to the client;
detecting whether the assigned IP address of the client conflicts with other clients and again detecting whether the IP address of the client conflicts with respective IP addresses of other clients after a random waiting time when the IP address of the client is not in conflict with other clients; and
keeping the assigned IP address of the client when the IP address of the client is not in conflict with other clients at the random waiting time.

12. The IP address automatic distribution method as claimed in claim 11, further comprising:
comparing values of MAC addresses of clients which conflict, to determine whether the value of the MAC address of the client meets a preset condition if the assigned IP address of the client is in conflict with one of other clients; and
detecting whether the IP address of the client conflicts with other clients after the random waiting time when the value of the MAC address of the client meets a preset condition.

13. The IP address automatic distribution method as claimed in claim 12, further comprising:
releasing the assigned address of the client when the MAC address of the client does not meet the preset condition.

14. The IP address automatic distribution method as claimed in claim 12, wherein the preset condition is the value of the MAC address of the client being the smallest.

15. The IP address automatic distribution method as claimed in claim 12, wherein the preset condition is the value of the MAC address of the client being the largest.

16. A client communicating with a switch which also communicating with other clients, the client and the other clients located in a same network segment, the client comprising:
an IP determining module configured to determine an IP address which has not been used according to internet protocol (IP) addresses and media access control (MAC) addresses of other clients transmitted from the switch and the network segment;
an IP assigning module configured to assign the IP address to the client;
a detecting module configured to detect whether the assigned IP address of the client conflicts with other clients and again detect whether the IP address of the client conflicts with other clients after a random waiting time when the IP address of the client is not conflict with other clients; and
a distribution module configured to keep the assigned IP address of the client when the IP address of the client is not conflict with other client at the random waiting time.

17. The client as claimed in claim 1, wherein the IP distribution module is further configured to release the assigned IP address of the client when the IP address of the client is in conflict with one of other clients at the random waiting time.

18. The client as claimed in claim 1, further comprising a comparing module, the comparing module is configured to compare values of MAC addresses of clients which conflict, to determine whether the value of the MAC address of the client meets a preset condition if the assigned IP address of the client is in conflict with one of other clients, the detecting module again detects whether the IP address of the client conflicts with other clients after the random waiting time when the value of the MAC address of the client meets a preset condition.

19. The IP address automatic distribution system as claimed in claim 18, wherein the IP distribution module is further configured to release the assigned address of the client when the MAC address of the client does not meet the preset condition.

20. The IP address automatic distribution system as claimed in claim 18, wherein the preset condition is the value of the MAC address of the client being the smallest.
